(19) United States
(12) Patent Application Publication
(10) Pub. No.: US 2025/0163284 A1
(43) Pub. Date: May 22, 2025

(54) INK COMPOSITION AND PRINTED MATERIAL COMPRISING THE SAME

(71) Applicant: Taeyoung Kim, Yongin-si (KR)

(72) Inventor: Taeyoung Kim, Yongin-si (KR)

(21) Appl. No.: 18/952,722

(22) Filed: Nov. 19, 2024

(30) Foreign Application Priority Data
Nov. 22, 2023 (KR) 10-2023-0162992
Nov. 13, 2024 (KR) 10-2024-0161072

(51) Int. Cl. C09D 11/06; C09D 11/037

(52) U.S. Cl. CPC C09D 11/06; C09D 11/037

(57) ABSTRACT

An ink composition and a printed material including the same. The ink composition disclosed herein may include denatonium benzoate.

### CROSS-REFERENCES TO RELATED APPLICATION

This application is based on and claims priority under 35 U.S.C. § 119 to Korean Patent Application Nos. 10-2023-0162992, filed on Nov. 22, 2023 and 10-2024-0161072, filed on Nov. 13, 2024, in the Korean Intellectual Property Office, the disclosures of which are incorporated by reference herein in their entirety.

### BACKGROUND

### 1. Field

The disclosure relates to an ink composition and a printed material including the ink composition. More particularly, the disclosure relates to an ink composition including denatonium benzoate having a bitter taste, and to a printed material including the ink composition, such that, when infants, toddlers or pets bring the printed material containing the ink composition to their mouths, the bitter taste causes them to naturally spit it out.

### 2. Description of the Related Art

Ink is broadly categorized into writing ink and printing ink. Writing ink is used for various purposes, including record-keeping, securities, symbols, drafting, stamping, and the like. Printing ink is either a colloidal substance or a liquid substance, primarily consisting of a colorant that includes pigments and a binder resin that fixes the colorant onto fibers. In manufacturing printing ink, a drying agent for adjusting the drying speed and additives for improving ink characteristics are added to a printing ink composition.

Meanwhile, ink raw materials are broadly classified into colorants, binder resins, solvents, and additives. Among these, pigments are primarily used as colorants. Offset ink pigments include yellow pigment Diazo Yellow (Pigment Yellow 12), red pigment Carmine 6B (Pigment Red 57:1), blue pigment Phthalocyanine Blue (Pigment Blue 15:3), and black pigment Carbon Black (Pigment Black 7), which enable printing in four basic colors: yellow, red, blue, and black.

For pigment dispersion, synthetic resins, such as rosin-modified phenolic resins, rosin esters, alkyd resins, and the like, and derivatives thereof are used as binder resins that form images on substrates to be printed during the printing process. Additionally, for solvents, high-boiling-point petrochemical solvents are used, and solvents with various boiling point ranges are selected according to ink properties.

Products printed with conventional ink (such as packaging materials, manuals, books, magazines, etc.) contained harmful components among the ink ingredients, presenting a problem where guardians always had to be cautious to prevent infants, toddlers, or pets from putting these items in their mouths.

### SUMMARY

Provided is an ink composition including denatonium benzoate having a bitter taste.

Provided is a printed material including the ink composition.

According to an aspect of the disclosure, an ink composition includes denatonium benzoate.

The ink composition may further include a vegetable oil.

The vegetable oil may include soybean oil, linseed oil, or a combination thereof.

The content of the denatonium benzoate may be about 100 parts by weight to about 900 parts by weight based on 100 parts by weight of the vegetable oil.

The ink composition may not include a petrochemical solvent.

The ink composition may further include a petrochemical solvent in an amount of more than 0 parts by weight and up to 50 parts by weight based on 100 parts by weight of the vegetable oil.

The ink composition may further include a binder resin in an amount of about 50 parts by weight to about 1,100 parts by weight based on 100 parts by weight of the vegetable oil.

The ink composition may not include a colorant.

The ink composition may further include a colorant in an amount of more than 0 parts by weight and up to 100 parts by weight based on 100 parts by weight of the vegetable oil.

The ink composition may further include an additive in an amount of about 20 parts by weight to about 100 parts by weight based on 100 parts by weight of the vegetable oil.

According to another aspect of the disclosure, a printed material includes the ink composition.

The printed material may be a children's book, a toy, a toy packaging, or a pet toy.

### DETAILED DESCRIPTION

Hereinbelow, an ink composition according to embodiments and a printed material including the same will be described in detail.

All terms and words used in the present specification and claims should not be limited to their dictionary meanings, but should be interpreted to have the meanings that are understood by those skilled in the art. Further, the terms and expressions as used herein are to be interpreted as having meanings consistent with the technical scope of the present disclosure. Therefore, the embodiments described herein are exemplary and non-limiting. Those skilled in the art will appreciate that various modifications, additions and substitutions may be possible at the time of filing, without departing from the scope and spirit of the disclosure. As used in the present specification, the term “ink composition” refers to a “printing ink composition” and is an inclusive term that encompasses both printing ink and printing ink coating solution.

As used in the present specification, “printing ink” refers to ink formulated for printing by various printers and means ink containing a colorant.

As used in the present specification, “printing ink coating solution” refers to a coating solution formulated for printing by various printers, meaning a coating solution from which the colorant has been removed from the printing ink.

As used in the present specification, “additive” refers to the remaining components of the ink composition, excluding vegetable oil, binder resin, petrochemical solvents, denatonium benzoate, and colorants.

The ink composition according to an embodiment may include denatonium benzoate.

Denatonium benzoate (C₃₈H₃₄N₂O₃), known as the most bitter compound discovered to date, may be represented by Formula 1 and has an extremely low bitterness threshold of 0.05 ppm. Traditionally used as a denaturant and flavoring agent to deter consumption of beverages, and typically exists as a colorless or white solid. Denatonium benzoate is poorly soluble in water but dissolves in organic solvents, and has no long-term health risks reported, allowing for safe usage. Denatonium benzoate is recognized by multiple bitter taste receptors and may also act as a bronchodilator in the respiratory smooth muscles.

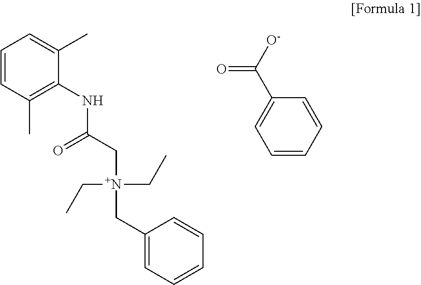 [SMILES: CC[N+](CC)(CC(=O)Nc1c(C)cccc1C)Cc1ccccc1 ; O=C([O-])c1ccccc1]

The content of the denatonium benzoate may be about 100 parts by weight to about 900 parts by weight based on 100 parts by weight of the vegetable oil.

With the content of denatonium benzoate being within the aforementioned range, the ink composition may provide the effect of causing infants, toddlers or pets to naturally spit out printed materials printed with the ink composition when placed in their mouths due to the bitter taste, while also providing the effect of preventing denatonium benzoate from rubbing off after printing and drying, and maintaining high print quality. The ink composition may further include a vegetable oil.

The vegetable oil may include soybean oil, linseed oil, or a combination thereof.

The soybean oil may have an iodine value in a range of about 125 to about 140, and a saponification value in a range of about 180 to about 200.

The ink composition may be free of petrochemical solvents.

Alternatively, the ink composition may further include a petrochemical solvent.

For example, the ink composition may further include more than 0 parts by weight and less than or equal to 50 parts by weight of a petrochemical solvent based on 100 parts by weight of the vegetable oil. With the content of the petrochemical solvent being within the aforementioned range, the following problems may be prevented: (i) significant reduction in biodegradability and renewability of the ink composition, (ii) deterioration of indoor air quality and potential respiratory irritation due to increased emission of volatile organic compounds (VOCs) from the ink composition, (iii) ink transfer problems and bleeding occurring during printing under inappropriate environmental conditions due to temperature and humidity sensitivity of petrochemical solvent-based inks, requiring precise control of printing room temperature (about 20-25° C.) and relative humidity (about 45-55%) to ensure high-quality printing, and (iv) increased content of petrochemical solvent leading to a stronger characteristic aromatic hydrocarbon odor, potentially degrading the work environment quality and negatively impacting the sensory properties of the final printed material. The petrochemical solvent may include a hydrocarbon solvent, mineral oil, white spirit, or a combination thereof.

The ink composition may further include a binder resin.

For example, the ink composition may further include about 50 parts by weight to about 1,100 parts by weight of a binder resin based on 100 parts by weight of the vegetable oil.

With the content of the binder resin being within the aforementioned range, the following problems may be prevented: (i) reduced ink tack leading to deterioration of print quality, (ii) insufficient dispersion of colorants resulting in poor color reproducibility, (iii) decreased ink durability, leading to reduced abrasion resistance and chemical resistance of printed materials, (iv) increased ink flowability causing bleeding or dot gain, (v) excessively increased high ink viscosity, leading to reduced flowability within printing machines, (vi) extended ink drying time, leading to reduced productivity and possible paper surface damage due to excessive tack, and (vii) decreased relative content of colorants resulting in reduced color strength. The binder resin may include rosin-modified phenol resin, rosin ester, alkyd resin, acrylic resin, epoxy resin, urethane resin, polyester resin, or a combination thereof.

The ink composition may be free of colorants.

In this case, the ink composition may be referred to as a “printing ink coating solution.” Alternatively, the ink composition may further include a colorant.

In this case, the ink composition may be referred to as a “printing ink.” For example, the ink composition may further include more than 0 parts by weight and up to 100 parts by weight of a colorant based on 100 parts by weight of the vegetable oil. With the content of the colorant being within the aforementioned range, the following problems may be prevented: (i) excessively increase high ink viscosity, leading to reduced flowability in printing machines, (ii) extended ink drying time, leading to reduced productivity, (iii) cracking or delamination of the printed material surface due to excessive colorant, (iv) reduced color uniformity due to agglomeration among colorants, and (v) increased ink costs. The colorant may include all conventionally known pigments, which may be organic or inorganic particles.

The pigments may include, without being limited to, black, white, cyan, magenta, and yellow pigments. Examples of suitable inorganic pigments may include carbon black, titanium dioxide, cobalt blue (CoO—Al₂O₃), chrome yellow (PbCrO₄), and iron oxide.

Examples of suitable organic pigments may include azo pigments (e.g., diazo and monoazo pigments), polycyclic pigments (e.g., phthalocyanine blue and green), perylene, perinone, anthraquinone, quinacridone, dioxazine, thioindigo, isoindolinone, pyranthrone, quinophthalone pigments, insoluble dye chelates, nitro pigments, nitroso pigments, and anthanthrone pigments (e.g., PR168).

Representative examples of pigments are as follows:
Phthalocyanine series: Pigment Blue 15, Pigment Green 7, Pigment Green 36
Quinacridone series: Pigment Orange 48, 49; Pigment Red 122, 192, 202, 206, 207, 209; Pigment Violet 19, 42
Anthraquinone series: Pigment Red 43, 194, 177, 216, 226
Perylene series: Pigment Red 123, 149, 179, 190, 189, 224
Thioindigo series: Pigment Red 86, 87, 88, 181, 198; Pigment Violet 36, 38
Heterocyclic yellow series: Pigment Yellow 1, 3, 12, 13, 14, 17, 65, 73, 74, 90, 110, 117, 120, 128, 138, 150, 151, 155, 213

These pigments are commercially available from BASF Corporation, Engelhard Corporation, Sun Chemical Corporation, and others.

Carbon pigments may be used as black pigments, including carbon black, graphite, amorphous carbon, charcoal, or a combination thereof.

Examples of suitable carbon black pigments may include various trade name pigments manufactured by Cabot, Columbian, Evonik, E.I. DuPont de Nemours and Company, and others. The particle size of the pigment may be preferably minimized to enable stable colloidal suspension in liquid vehicles and to prevent clogging in inkjet printers.

In the present disclosure, white pigments and colored pigments may be mixed to obtain desired colors.

Relative to 100 parts by weight of the total ink composition, hiding power and dispersibility may be maximized when the pigment content is about 5 parts by weight to about 50 parts by weight, and for example, hiding power and dispersibility may be maximized when the pigment content is preferably about 10 parts by weight to about 40 parts by weight of white pigment and about 2 parts by weight to about 10 parts by weight of colored pigment, and more preferably about 10 parts by weight to about 36 parts by weight of white pigment and about 2 parts by weight to about 7 parts by weight of colored pigment. Examples of colored pigments may include:
Magenta: PR-146, PR-122, PR-176, PR48:1, PR49:1, PR53:1, PV19
Yellow: PY-14, PY-83, PY-74, PY-13
Cyan: PB-15:3, PB 15:4
Black: PB-7

The ink composition may further include an additive.

For example, the ink composition may further include an additive in an amount of about 20 parts by weight to about 100 parts by weight based on 100 parts by weight of the vegetable oil. With the content of the additive being within the aforementioned range, printing quality and durability of the printed material may be improved. In the field of printing ink or printing ink coating solution, not only the individual amount of each additive, but also the total amount of all additives may be critical for the following reasons: (i) the total amount of additives is essential for maintaining balance with other ink components, as excessive total additive content may alter the ink's basic properties; (ii) when multiple additives are used together, they may interact to produce unexpected effects, and managing the total amount of additives helps control these interactions; (iii) an appropriate total additive content enables optimization of ink viscosity, drying speed, and stability, thereby maintaining high print quality; (iv) an appropriate total amount of additives ensures the ink's long-term storage stability and stability during the printing process; and (v) the total amount of additives may affect the ink's environmental friendliness and safety.

The additive may include a drier (manganese-based drier, cobalt-based drier), gelling agent, antioxidant, sizing agent (starch), emulsion stabilizer, wax, inorganic filler, fatty acid ester (fatty acid methyl ester), or a combination thereof.

The ink composition according to embodiments, having the aforementioned configuration, may express bitterness without causing toxicity and may simultaneously offer the advantage of excellent print quality when printed.

Hereinbelow, a printed material according to embodiments will be described in greater detail.

The printed material may include the ink composition.

The printed material may be a children's book, toy, toy packaging, or pet toy.

The disclosure will be described in detail with reference to the following examples, which are provided for illustrative purposes only and are not intended to limit the scope of the disclosure.

### Example 1: Preparation of Ink Composition

An ink composition was prepared by mixing 100 parts by weight of soybean oil (iodine value: 130, saponification value: 190), 400 parts by weight of denatonium benzoate, 133 parts by weight of a binder resin, 50 parts by weight of a colorant, and 60 parts by weight of an additive.

The binder resin is ethyl acrylate, the colorant is a mixture of 50 parts by weight of titanium dioxide and 50 parts by weight of Pigment Red 43, and the additive is a mixture of 3 parts by weight of a manganese-based drying agent, 3 parts by weight of a gelling agent (carrageenan), 3 parts by weight of an antioxidant (rosemary extract), 10 parts by weight of starch, 3 parts by weight of an emulsion stabilizer (stearic acid), 9 parts by weight of wax, 25 parts by weight of an inorganic filler (alumina), and 44 parts by weight of fatty acid methyl ester.

### Example 2: Preparation of Ink Composition

An ink composition was prepared using the same method as Example 1, except that the content of denatonium benzoate was changed to 100 parts by weight based on 100 parts by weight of the soybean oil.

### Example 3: Preparation of Ink Composition

An ink composition was prepared using the same method as Example 1, except that the content of denatonium benzoate was changed to 900 parts by weight based on 100 parts by weight of the soybean oil.

### Example 4: Preparation of Ink Composition

An ink composition was prepared using the same method as Example 1, except that the content of the binder resin was changed to 50 parts by weight based on 100 parts by weight of the soybean oil.

### Example 5: Preparation of Ink Composition

An ink composition was prepared using the same method as Example 1, except that the content of the binder resin was changed to 1,100 parts by weight based on 100 parts by weight of the soybean oil.

### Example 6: Preparation of Ink Composition

An ink composition was prepared using the same method as Example 1, except that the content of the colorant was changed to 100 parts by weight based on 100 parts by weight of the soybean oil.

### Example 7: Preparation of Ink Composition (Ink Coating Solution)

An ink composition (ink coating solution) was prepared using the same method as Example 1, except that the content of the colorant was changed to 0 parts by weight based on 100 parts by weight of the soybean oil.

### Example 8: Preparation of Ink Composition

An ink composition was prepared using the same method as Example 1, except that the content of the additive was changed to 20 parts by weight based on 100 parts by weight of the soybean oil.

### Example 9: Preparation of Ink Composition

An ink composition was prepared using the same method as Example 1, except that the content of the additive was changed to 100 parts by weight based on 100 parts by weight of the soybean oil.

### Example 10: Preparation of Ink Composition

An ink composition was prepared using the same method as Example 1, except that 25 parts by weight of a petrochemical solvent (butyl acetate) were further added based on 100 parts by weight of the soybean oil.

### Example 11: Preparation of Ink Composition

An ink composition was prepared using the same method as Example 1, except that 50 parts by weight of a petrochemical solvent (butyl acetate) were further added based on 100 parts by weight of the soybean oil.

### Reference Example 1: Preparation of Ink Composition

An ink composition was prepared using the same method as Example 1, except that the content of denatonium benzoate was changed to 90 parts by weight based on 100 parts by weight of the soybean oil.

### Reference Example 2: Preparation of Ink Composition

An ink composition was prepared using the same method as Example 1, except that the content of denatonium benzoate was changed to 910 parts by weight based on 100 parts by weight of the soybean oil.

### Reference Example 3: Preparation of Ink Composition

An ink composition was prepared using the same method as Example 1, except that the content of the binder resin was changed to 40 parts by weight based on 100 parts by weight of the soybean oil.

### Reference Example 4: Preparation of Ink Composition

An ink composition was prepared using the same method as Example 1, except that the content of the binder resin was changed to 1,110 parts by weight based on 100 parts by weight of the soybean oil.

### Reference Example 5: Preparation of Ink Composition

An ink composition was prepared using the same method as Example 1, except that the content of the colorant was changed to 110 parts by weight based on 100 parts by weight of the soybean oil.

### Reference Example 6: Preparation of Ink Composition

An ink composition was prepared using the same method as Example 1, except that the content of the additive was changed to 10 parts by weight based on 100 parts by weight of the soybean oil.

### Reference Example 7: Preparation of Ink Composition

An ink composition was prepared using the same method as Example 1, except that the content of the additive was changed to 110 parts by weight based on 100 parts by weight of the soybean oil.

### Reference Example 8: Preparation of Ink Composition

An ink composition was prepared using the same method as Example 1, except that 60 parts by weight of a petrochemical solvent (butyl acetate) were further added based on 100 parts by weight of the soybean oil.

The compositions of the ink compositions prepared in Examples 1 to 10 and Reference Examples 1 to 8 are summarized in Table 1 below.

TABLE 1

| | Composition of Ink Composition (parts by weight) | | | | | |
|---|---|---|---|---|---|---|
| | Soybean | Denatonium | Binder | Petrochemical | | |
| | oil | benzoate | resin | Solvent | Colorant | Additives |
| Example 1 | 100 | 400 | 133 | 0 | 50 | 60 |
| Example 2 | 100 | 100 | 133 | 0 | 50 | 60 |
| Example 3 | 100 | 900 | 133 | 0 | 50 | 60 |
| Example 4 | 100 | 400 | 50 | 0 | 50 | 60 |
| Example 5 | 100 | 400 | 1100 | 0 | 50 | 60 |
| Example 6 | 100 | 400 | 133 | 0 | 100 | 60 |
| Example 7 | 100 | 400 | 133 | 0 | 0 | 60 |
| Example 8 | 100 | 400 | 133 | 0 | 50 | 20 |
| Example 9 | 100 | 400 | 133 | 0 | 50 | 100 |
| Example 10 | 100 | 400 | 133 | 25 | 50 | 60 |
| Example 11 | 100 | 400 | 133 | 50 | 50 | 60 |
| Reference | 100 | 90 | 133 | 0 | 50 | 60 |
| Example 1 | | | | | | |
| Reference | 100 | 910 | 133 | 0 | 50 | 60 |
| Example 2 | | | | | | |
| Reference | 100 | 400 | 40 | 0 | 50 | 60 |
| Example 3 | | | | | | |
| Reference | 100 | 400 | 1110 | 0 | 50 | 60 |
| Example 4 | | | | | | |
| Reference | 100 | 400 | 133 | 0 | 110 | 60 |
| Example 5 | | | | | | |
| Reference | 100 | 400 | 133 | 0 | 50 | 10 |
| Example 6 | | | | | | |
| Reference | 100 | 400 | 133 | 0 | 50 | 110 |
| Example 7 | | | | | | |
| Reference | 100 | 400 | 133 | 60 | 50 | 60 |
| Example 8 | | | | | | |

### Evaluation Example 1: Print Quality Evaluation

The ink compositions prepared in Examples 1 to 10 and Reference Examples 1 to 8 were printed on fabric using a printer, and then, were evaluated for color development (colorant dispersibility), scratch resistance, and water resistance.

The color development was evaluated by printing a flower pattern on fabric using each ink composition, then having 20 men and 20 women with the same visual acuity (0.8-1.0) evaluate the printed material on a 5-point scale, with the average values shown in Table 2.

A score closer to 5 on the color development evaluation indicates superior color development. The above scratch resistance was evaluated using a 5-point scale by applying constant pressure to the fiber that had completed the above color development evaluation and scratching it transversely, measuring the degree to which the ink peeled off from the fiber. The average values are shown in Table 2 below.

The water resistance was measured using a Gakushin-type color fastness to rubbing tester (manufactured by Yasuda Seiki Seisakusho Co., Ltd.) on the fabric after the color development evaluation.

A rubbing test was performed 25 times using a water-dampened gauze. The fabric staining (i.e., whether water was absorbed into the fabric) was visually assessed and recorded in Table 2.

### Evaluation Example 2: Bitterness Evaluation

The bitterness of the ink compositions prepared in Examples 1 to 10 and Reference Examples 1 to 8 was evaluated.

Twenty men and twenty women were asked to taste the ink compositions using a cotton swab and evaluate on a 5-point scale, with the average values shown in Table 2.

TABLE 2

| | Color | Scratch | Water | |
|---|---|---|---|---|
| | development | resistance | resistance | Bitterness |
| Example 1 | 4.5 | 4.7 | No staining | 3 |
| Example 2 | 4.4 | 4.8 | No staining | 3 |
| Example 3 | 4.6 | 4.6 | No staining | 3 |
| Example 4 | 4.5 | 4.6 | No staining | 3 |
| Example 5 | 4.5 | 4.5 | No staining | 3 |
| Example 6 | 4.5 | 4.7 | No staining | 3 |
| Example 7 | Unmeasurable | 4.8 | No staining | 3 |
| Example 8 | 4.5 | 4.6 | No staining | 3 |
| Example 9 | 4.4 | 4.6 | No staining | 3 |
| Example 10 | 4.5 | 4.5 | No staining | 3 |
| Example 11 | 4.4 | 4.8 | No staining | 3 |
| Reference Example 1 | 4.5 | 4.6 | No staining | 1 |
| Reference Example 2 | 2.1 | 4.7 | No staining | 5 |
| Reference Example 3 | 1.1 | 3.9 | No staining | 3 |
| Reference Example 4 | 2.0 | 5.0 | No staining | 3 |
| Reference Example 5 | 2.3 | 4.6 | No staining | 3 |
| Reference Example 6 | 4.5 | 4.7 | Staining | 3 |
| Reference Example 7 | 3.2 | 4.6 | No staining | 3 |
| Reference Example 8 | 4.5 | 4.7 | No staining | 2 |

Referring to Table 2 above, the ink compositions manufactured in Examples 1-6 and 8-11 not only demonstrated excellent print quality due to superior color development (pigment dispersibility), scratch resistance, and water resistance, but also scored 3 or higher in bitterness evaluation. This indicates that if infants or pets put printed materials using these ink compositions in their mouths, they would immediately spit them out due to the bitter taste.

Meanwhile, the ink composition manufactured in Example 7 not only demonstrated excellent print quality due to superior scratch resistance and water resistance, but also scored 3 or higher in bitterness evaluation. This indicates that if infants, toddlers or pets put printed materials using this ink composition in their mouths, they would immediately spit them out due to the bitter taste. However, the color development was reported as ‘unmeasurable’. This is because the inventors intentionally did not add any colorants to use this ink composition as a printing ink coating solution rather than as a printing ink.

Additionally, the ink composition prepared in Example 7 demonstrated excellent transparency, making it suitable for use as a printing ink coating solution. In contrast, the ink compositions prepared in Reference Examples 1 to 8 showed poor performance in at least one of the color development (pigment dispersibility), the scratch resistance, and the water resistance, or achieved bitterness ratings below 3, indicating that infants, toddlers or pets would not immediately spit out printed materials if placed in their mouths due to insufficient bitter taste.

According to embodiments, the ink composition includes denatonium benzoate providing a bitter taste, which causes infants, toddlers or pets to naturally spit out printed materials if placed in their mouths.

The advantages of the disclosure are not limited to those mentioned above, and other unmentioned advantages would be clearly understood by those skilled in the art from the foregoing description.

While the disclosure has been described with reference to specific embodiments, it will be apparent to those skilled in the art that various changes and modifications may be made without departing from the spirit and scope of the disclosure.

Therefore, the scope of protection of the disclosure should be determined by the appended claims. It should be understood that embodiments described herein should be considered in a descriptive sense only and not for purposes of limitation.

Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

I claim:

1. An ink composition comprising denatonium benzoate.

2. The ink composition of claim 1, further comprising a vegetable oil.

3. The ink composition of claim 2, wherein the vegetable oil comprises soybean oil, linseed oil, or a combination thereof.

4. The ink composition of claim 2, wherein a content of the denatonium benzoate is about 100 parts by weight to about 900 parts by weight based on 100 parts by weight of the vegetable oil.

5. The ink composition of claim 2, wherein the ink composition does not comprise a petrochemical solvent.

6. The ink composition of claim 2, further comprising a petrochemical solvent in an amount of more than 0 parts by weight and up to 50 parts by weight based on 100 parts by weight of the vegetable oil.

7. The ink composition of claim 2, further comprising a binder resin in an amount of about 50 parts by weight to about 1,100 parts by weight based on 100 parts by weight of the vegetable oil.

8. The ink composition of claim 1, wherein the ink composition does not comprise a colorant.

9. The ink composition of claim 2, further comprising a colorant in an amount of more than 0 parts by weight and up to 100 parts by weight based on 100 parts by weight of the vegetable oil.

10. The ink composition of claim 2, further comprising an additive in an amount of about 20 parts by weight to about 100 parts by weight based on 100 parts by weight of the vegetable oil.

11. A printed material comprising the ink composition according to claim 1.

12. The printed material of claim 11, wherein the printed material is a children's book, a toy, a toy packaging, or a pet toy.
